(19) United States
(12) Patent Application Publication
(10) Pub. No.: US 2025/0364818 A1
(43) Pub. Date: Nov. 27, 2025

(54) BATTERY BALANCING CIRCUIT FOR BALANCING BATTERY PACK AND ASSOCIATED METHOD

(71) Applicant: Chengdu Monolithic Power Systems Co., Ltd., Chengdu (CN)

(72) Inventor: Shuai Wang, Hangzhou (CN)

(21) Appl. No.: 19/213,846

(22) Filed: May 20, 2025

(30) Foreign Application Priority Data
May 21, 2024 (CN) CN202410634583.7

(51) Int. Cl. H02J 7/00

(52) U.S. Cl. CPC H02J 7/0019

(57) ABSTRACT

A battery balancing circuit for a battery pack with n battery cells connected in series is provided. The battery balancing circuit includes m bridge arms. Each of the m bridge arms includes a high-side switch and a low-side switch. A second terminal of the high-side switch is coupled to a first terminal of the low-side switch to form a middle node. Each middle node of the m bridge arms is coupled to a first terminal of an inductor. One of the m high-side switches and one of the m low-side switches are selected as a pair of operating switches, and alternately turned on and off to couple the first terminal of the inductor to an anode of a first target battery cell from a first battery group of the battery pack and a cathode of a second target battery cell from a second battery group of the battery pack.

### CROSS-REFERENCE TO RELATED APPLICATIONS

This application claims the benefit of and priority to a CN application 202410634583.7, filed on May 21, 2024, which is incorporated herein by reference into the present application.

### TECHNICAL FIELD

The present disclosure relates generally to electronic circuits, and more particularly but not exclusively to battery balancing circuits, battery balancing systems and associated methods.

### BACKGROUND OF THE INVENTION

A battery pack typically includes several battery cells connected in series. Since the characteristics such as charging status, impedance, and temperature in each battery cell are different, after several charge and discharge cycles, the battery cells may be mis-matched, i.e., the battery pack is unbalanced or un-equalized. For instance, the mis-matched battery cells may reduce the capacity and the life span of the battery pack. Thus, it is necessary to use a battery balancing circuit to balance the battery pack, for ensuring the capacity and prolonging the life span of the battery pack.

### SUMMARY OF THE INVENTION

According to an embodiment of the present disclosure, the battery balancing circuit for a battery pack is provided. The battery pack includes n battery cells connected in series. The battery balancing circuit includes m bridge arms. Each of the m bridge arms includes a high-side switch and a low-side switch coupled in series. A second terminal of the high-side switch is coupled to a first terminal of the low-side switch to form a middle node. Each middle node of the m bridge arms is configured to be coupled to a first terminal of an inductor. One of the m high-side switches and one of the m low-side switches are operable to be selected as a pair of operating switches, and alternately turned on and off to couple the first terminal of the inductor to an anode of a first target battery cell from a first battery group of the battery pack and a cathode of a second target battery cell from a second battery group of the battery pack.

According to another embodiment of the present disclosure, a battery balancing system is provided. The battery balancing system includes a battery pack and a battery balancing circuit. The battery pack has n battery cells connected in series. The battery balancing circuit includes m bridge arms. Each of the m bridge arms includes a high-side switch and a low-side switch coupled in series. A second terminal of the high-side switch is coupled to a first terminal of the low-side switch to form a middle node. Each middle node of the m bridge arms is configured to be coupled to a first terminal of an inductor. One of the m high-side switches and one of the m low-side switches are operable to be selected as a pair of operating switches, and alternately turned on and off to couple the first terminal of the inductor to an anode of a first target battery cell and a cathode of a second target battery cell. When n is an even number, m=n/2, the first target battery cell is one of a [(n/2)+1]th battery cell to a nth battery cell, the second target battery cell is one of a 1st battery cell to a (n/2)th battery cell, and a second terminal of the inductor is coupled to an anode of the (n/2) th battery cell. When n is an odd number, m=(n−1)/2, the first target battery cell is one of a {[(n+1)/2]+1}th battery cell to the nth battery cell, the second target battery cell is one of the 1st battery cell to a {[(n+1)/2]−1}th battery cell, and the second terminal of the inductor is configured to be selectively coupled to an anode or a cathode of a [(n+1)/2]th battery cell.

According to yet another embodiment of the present disclosure, a method for balancing a battery pack is provided. The battery pack includes n battery cells connected in series. The method includes the following actions. m bridge arms are provided. Each of the m bridge arms includes a high-side switch and a low-side switch coupled in series. A second terminal of the high-side switch is coupled to a first terminal of the low-side switch to form a middle node, and each middle node of the m bridge arms is coupled to a first terminal of an inductor. One of the m high-side switches and one of the m low-side switches are selected as a pair of operating switches. The pair of operating switches are turned on and off alternately to couple the first terminal of the inductor to an anode of a first target battery cell or a cathode of a second target battery cell. When n is an even number, m=n/2, the first target battery cell is one of a [(n/2)+1]th battery cell to a nth battery cell, the second target battery cell is one of a 1st battery cell to a (n/2)th battery cell, and a second terminal of the inductor is configured to be coupled to an anode of the (n/2)th battery cell. When n is an odd number, m=(n−1)/2, the first target battery cell is one of a {[(n+1)/2]+1}th battery cell to the nth battery cell, the second target battery cell is one of the 1st battery cell to a {[(n+1)/2]−1}th battery cell, and the second terminal of the inductor is configured to be selectively coupled to an anode or a cathode of the [(n+1)/2]th battery cell.

### BRIEF DESCRIPTION OF THE DRAWINGS

The present disclosure can be further understood with reference to the following detailed description and appended drawings, where like elements are provided with like reference numerals. These drawings are only for illustration purpose, thus may only show part of the devices and are not necessarily drawn to scale.

FIG. 1 schematically shows a passive balancing circuit.

FIG. 2 schematically shows an active balancing circuit.

FIG. 3 schematically shows another active balancing circuit.

FIG. 4 schematically shows a battery balancing circuit for a battery pack in accordance with one embodiment of the present disclosure.

FIG. 5 schematically shows a battery balancing circuit for a battery pack in accordance with another embodiment of the present disclosure.

FIG. 6 schematically shows a battery balancing circuit for a battery pack with four battery cells connected in series in accordance with one embodiment of the present disclosure.

FIGS. 7A-7D schematically show the battery balancing circuit shown in FIG. 6 operating in different modes in accordance with one embodiment of the present disclosure.

FIG. 8 schematically shows a battery balancing circuit for a battery pack with five battery cells connected in series in accordance with one embodiment of the present disclosure.

FIGS. 9A-9D schematically show the battery balancing circuit shown in FIG. 8 operating in different modes in accordance with one embodiment of the present disclosure.

FIG. 10 schematically shows a battery balancing system in accordance with one embodiment of the present disclosure.

FIG. 11 shows a flowchart of a method for balancing a battery pack in accordance with one embodiment of the present disclosure.

### DETAILED DESCRIPTION

Various embodiments of the present disclosure will now be described. In the following description, some specific details, such as example circuits and example values for these circuit components, are included to provide a thorough understanding of embodiments. One skilled in the relevant art will recognize, however, that the present disclosure can be practiced without one or more specific details, or with other methods, components, materials, etc. In other instances, well-known structures, materials, processes or operations are not shown or described in detail to avoid obscuring aspects of the present disclosure.

Throughout the specification and claims, the phrases “in one embodiment”, “in some embodiments”, “in one implementation”, and “in some implementations” as used includes both combinations and sub-combinations of various features described herein as well as variations and modifications thereof. These phrases used herein do not necessarily refer to the same embodiment, although it may. Those skilled in the art should understand that the meanings of the terms identified above do not necessarily limit the terms, but merely provide illustrative examples for the terms. It is noted that when an element is “connected to” or “coupled to” the other element, it means that the element is directly connected to or coupled to the other element, or indirectly connected to or coupled to the other element via another element. Particular features, structures or characteristics may be included in an integrated circuit, an electronic circuit, a combinational logic circuit, or other suitable components that provide the described functionality. In addition, it is appreciated that the figures provided herewith are for explanation purposes to persons ordinarily skilled in the art and that the drawings are not necessarily drawn to scale.

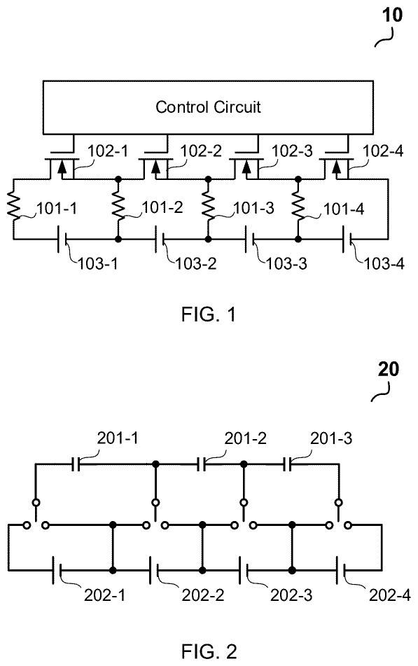

FIG. 1 schematically shows a passive balancing circuit 10. As shown in FIG. 1, the passive balancing circuit 10 includes bypass resistors 101 (i.e., 101-1, 101-2, 101-3, 101-4) and bypass field effect transistors (FETs) 102 (i.e., 102-1, 102-2, 102-3, 102-4) connected to battery cells 103 (i.e., 103-1, 103-2, 103-3, 103-4). In the passive balancing circuit 10, when the battery cell (e.g., 103-4) has a relatively high voltage, the bypass FET 102-4 is turned on. The battery cell 103-4 is discharged through the bypass resistor 101-4 and the bypass FET 102-4, therefore the voltage of the battery cell 103-4 is reduced. In other words, the energy of the battery cell 103-4 is dissipated by the bypass resistor 101-4. However, only the battery cell with the relatively high voltage could be regulated by the passive balancing circuit 10, and the efficiency is low due to the power dissipation.

FIG. 2 schematically shows an active balancing circuit 20. As shown in FIG. 2, the active balancing circuit 20 includes capacitors 201 (i.e., 201-1, 201-2, 201-3) and battery cells 202 (i.e., 202-1, 202-2, 202-3, 202-4). The capacitor 201 is coupled between each two adjacent battery cells 202 selectively to balance the voltages of the two adjacent battery cells 202. For example, the capacitor 201-1 is coupled between the battery cell 202-1. The battery cell 202-1 is discharged, and the energy of the battery cell 202-1 is stored in the capacitor 202-1. Subsequently, the capacitor 201-1 is coupled between the battery cell 202-2. The energy stored in the capacitor 202-1 is provided to the battery cell 202-2, thus the battery cell 202-2 is charged. Therefore, energy transfer between the battery cells 202-1 and 202-2 is realized. However, only two adjacent battery cells 202 could be regulated in one charge/discharge process of the active balancing circuit 20. Furthermore, the efficiency of the active balancing circuit 20 is low because a lot of energy is wasted during the charge/discharge process of the capacitors 201.

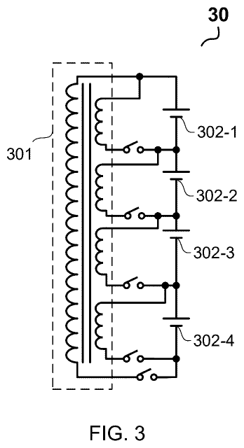

FIG. 3 schematically shows another active balancing circuit 30. As shown in FIG. 3, the active balancing circuit 30 includes a transformer 301, and energy can be transferred between battery cells 302 (i.e., 302-1, 302-2, 302-3, 302-4) through the transformer 301. For example, when the battery cell 302-1 is coupled to the transformer 301, the transformer 301 stores the energy from the battery cell 302-1. Subsequently, the battery cell 302-4 is coupled to the transformer 301, and the energy stored in the transformer 301 is provided to the battery cell 302-4. Therefore, energy transfer between the battery cells 302-1 and 302-4 is realized. However, the size and cost of the active balancing circuit 30 are increased because of the transformer 301.

As previously mentioned, the balancing circuits 10, 20 and 30 have the disadvantages of low efficiency, large size and high cost. In order to address the above problems, the present disclosure provides battery balancing circuits, battery balancing systems and associated methods that could improve the balancing efficiency and reduce the cost and size of the circuit.

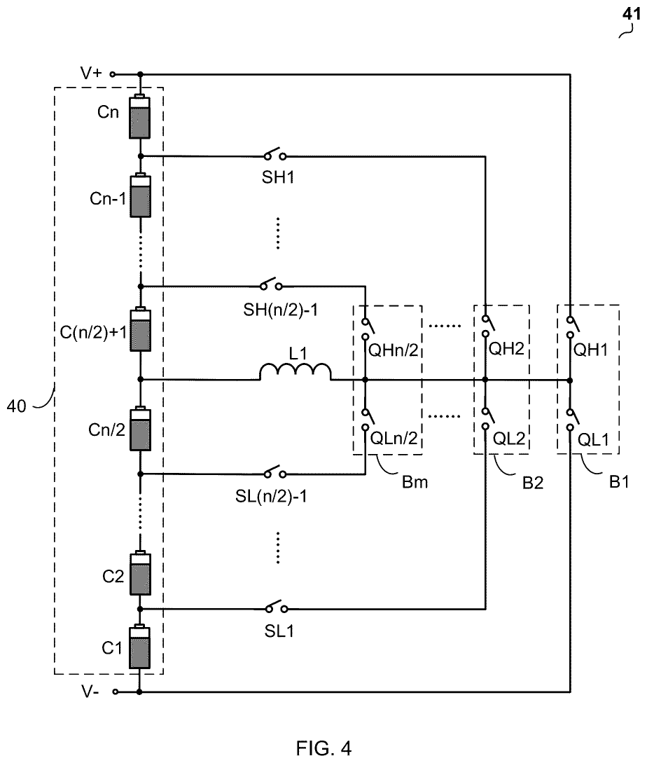

FIG. 4 schematically shows a battery balancing circuit 41 for a battery pack 40 in accordance with one embodiment of the present disclosure. As shown in FIG. 4, the battery pack 40 is coupled between a battery pack terminal V+ and a battery pack terminal V−. In one embodiment, the battery pack 40 includes n battery cells coupled in series, where n is an even number higher than 4 or equal to 4. The battery pack 40 includes the 1st battery cell C1, the 2nd battery cell C2, . . . , and the nth battery cell Cn.

In the embodiment of FIG. 4, the battery balancing circuit 41 includes m bridge arms B1-Bm and an inductor L1, where m=n/2. Each of the m bridge arms B1-Bm includes a high-side switch QH and a low-side switch QL. In other words, there are m high-side switches QH1-QHn/2 and m low-side switches QL1-QLn/2. The high-side switch QH has a first terminal and a second terminal, and the low-side switch QL has a first terminal and a second terminal. As shown in FIG. 4, the second terminal of the high-side switch QH is coupled to the first terminal of the low-side switch QL to form a middle node. In each of the m bridge arms B1-Bm, the middle node formed by the high-side switch QH and the low-side switch QL is coupled to a first terminal of the inductor L1.

As shown in FIG. 4, the 1st high-side switch QH1 of the 1st bridge arm B1 is coupled to the anode of the nth battery cell Cn (i.e., the battery pack terminal V+), and the 1st low-side switch QL1 of the 1st bridge arm B1 is coupled to the cathode of the 1st battery cell C1 (i.e., the battery pack terminal V−); the 2nd high-side switch QH2 of the 2nd bridge arm B2 is coupled to the anode of the (n−1)th battery cell Cn−1, and the 2nd low-side switch QL2 of the 2nd bridge arm B2 is coupled to the cathode of the 2nd battery cell C2; . . . ; and the (n/2)th high-side switch QHn/2 of the mth bridge arm Bm is coupled to the anode of the [(n/2)+1]th battery cell C(n/2)+1, and the (n/2)th low-side switch QLn/2 of the mth bridge arm Bm is coupled to the cathode of the (n/2) th battery cell Cn/2. Meanwhile, a second terminal of the inductor L1 is coupled to the anode of the (n/2)th battery cell Cn/2.

In the embodiments of the present disclosure, one of the m high-side switch QH1-QHn/2 and one of the m low-side switch QL1-QLn/2 are selected as a pair of operating switches based on energy transfer demand between the battery cells C1-Cn. The pair of operating switches are turned on and off alternately such that the first terminal of the inductor L1 is coupled to the anode of a first target battery cell and the cathode of a second target battery cell alternately, thereby realizing energy transfer between the battery cells C1-Cn.

In one embodiment, the battery pack 40 includes a first battery group and a second battery group. The first battery group has a first terminal coupled to the battery pack terminal V+ and a second terminal. The second battery group has a first terminal, and a second terminal coupled to the battery pack terminal V−. The second terminal of the first battery group is coupled to the first terminal of the second battery group. The first target battery cell is one of the first battery group, and the second target battery is one of the second battery group. In the embodiment of FIG. 4, the first battery group includes n/2 battery cells from the [(n/2)+1]th battery cell C(n/2)+1 to the nth battery cell Cn, and the second target battery includes n/2 battery cells from the 1st battery cell C1 to the (n/2)th battery cell Cn/2. As shown in FIG. 4, the second terminal of the inductor L1 is coupled to the second terminal of the first battery group or the first terminal of the second battery group. In one embodiment, the first target battery cell or the second target battery cell is a battery cell having the highest voltage in the battery pack 40. In another embodiment, the first target battery cell or the second target battery cell is a battery cell having the lowest voltage in the battery pack 40.

In the embodiment of FIG. 4, the battery balancing circuit 41 further includes m−1 high-side blocking switches SH1-SH(n/2)−1 and m−1 low-side blocking switches SL1-SL(n/2)−1. The m−1 high-side blocking switches SH1-SH(n/2)−1 are configured to be coupled in series with the corresponding high-side switches QH2-QHn/2 of the bridge arms B2-Bm, respectively. The high-side blocking switch SH and the corresponding high-side switch QH are coupled in opposite directions. Therefore, when the high-side switch QH is turned off, the current flowing through the high-side switch QH could be effectively blocked by the corresponding high-side blocking switch SH. Similarly, the m−1 low-side blocking switches SL1-SL(n/2)−1 are configured to be coupled in series with the corresponding low-side switches QL2-QLn/2 of the bridge arms B2-Bm, respectively. The low-side blocking switch SL and the corresponding low-side switch QL are coupled in opposite directions. Therefore, when the low-side switch QL is turned off, the current flowing through the low-side switch QL could be effectively blocked by the corresponding low-side blocking switch SL. In some embodiments, the 1st high-side blocking switch SH1 and the 2nd high-side switch QH2 are N-type metal oxide semiconductor field effect transistors (N-MOSFETs), the cathode of the body diode of the 1st high-side blocking switch SH1 is coupled to the cathode of the body diode of the 2nd high-side switch QH2 to realize the blocking of the current. In some other embodiments, the anode of the body diode of the 1st high-side blocking switch SH1 is coupled to the anode of the body diode of the 2nd high-side switch QH2 to realize the blocking of the current.

As shown in FIG. 4, the 2nd high-side switch QH2 of the 2nd bridge arm B2 is coupled to the anode of the (n−1)th battery cell Cn−1 through the 1st high-side blocking switch SH1, the 2nd low-side switch QL2 is coupled to the cathode of the 2nd battery cell C2 through the 1st low-side blocking switch SL1; . . . ; and the (n/2)th high-side switch QHn/2 of the mth bridge arm Bm is coupled to the anode of the [(n/2)+1]th battery cell C(n/2)+1 through the [(n/2)−1]th high-side blocking switch SH(n/2)−1, and the (n/2)th low-side switch QLn/2 of the mth bridge arm Bm is coupled to the cathode of the (n/2)th battery cell Cn/2 through the [(n/2)−1]th low-side blocking switch SL(n/2)−1.

In some embodiments, when the one of the m high-side switches QH is selected as the operating switch, the high-side blocking switch SH coupled in series with the selected high-side switch QH is turned on. When the one of the m low-side switches QL is selected as the operating switch, the low-side blocking switch SL coupled in series with the selected low-side switch QL is turned on.

For example, when the 2nd battery cell C2 is the second target battery cell (i.e., the 2nd battery cell C2 has the highest or lowest voltage in the battery pack 40), the 2nd low-side switch QL2 is selected as one of the pair of operating switches. Meanwhile, the 1st low-side blocking switch SL1 coupled in series with the 2nd low-side switch QL2 is turned on. Therefore, the first terminal of the inductor L1 is coupled to the cathode of the 2nd battery cell C2. For another example, when the (n−1)th battery cell Cn−1 is the first target battery cell (i.e., the (n−1)th battery cell Cn−1 has the highest or lowest voltage in the battery pack 40), the 2nd high-side switch QH2 is selected as one of the pair of operating switches. Meanwhile, the 1st high-side blocking switch SH1 coupled in series with the 2nd high-side switch QH2 is turned on. Therefore, the first terminal of the inductor L1 is coupled to the anode of the (n−1) th battery cell Cn−1.

In one embodiment, when the 1st high-side switch QH1 and the 1st low-side switch QL1 are selected as the pair of operating switches. Energy transfer between battery cells C1-Cn/2 and battery cells C[(n/2)+1]-Cn could be realized by turning on and off the 1st high-side switch QH1 and the 1st low-side switch QL1 alternately.

In one embodiment, when the 2nd high-side switch QH2 and the 2nd low-side switch QL2 are selected as the pair of operating switches, the 1st high-side blocking switch SH1 and the 1st low-side blocking switch SL1 are turned on. Energy transfer between the battery cells C2-Cn/2 and the battery cells C[(n/2)+1]-Cn−1 could be realized by turning on and off the 2nd high-side switch QH2 and the 2nd low-side switch QL2 alternately.

In one embodiment, when the 1st high-side switch QH1 and the (n/2)th low-side switch QLn/2 are selected as the pair of operating switches, the (n/2)th low-side blocking switch SL(n/2)−1 is turned on. Energy transfer between the (n/2)th battery cell Cn/2 and the battery cells C[(n/2)+1]-Cn could be realized by turning on and off the 1st high-side switch QH1 and the (n/2)th low-side switch QLn/2 alternately.

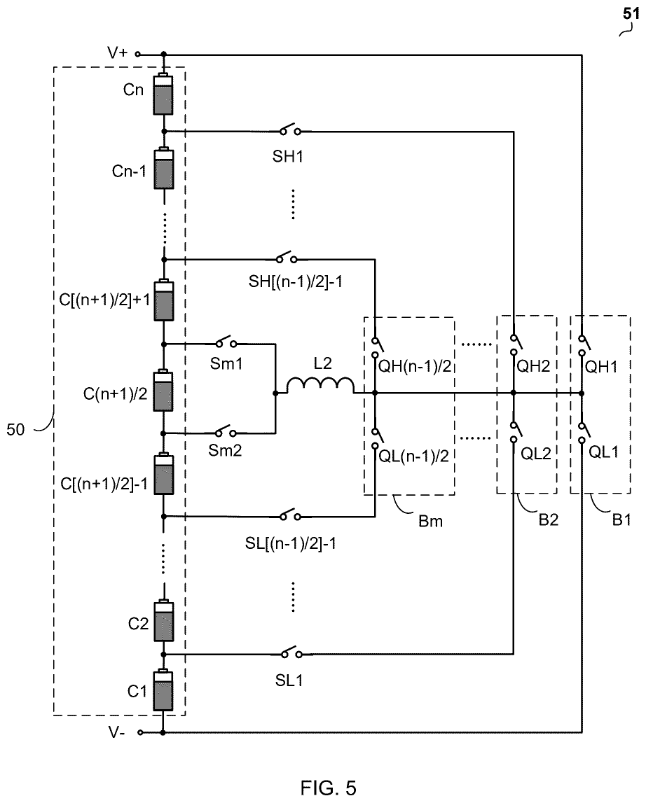

FIG. 5 schematically shows a battery balancing circuit 51 for a battery pack 50 in accordance with one embodiment of the present disclosure. As shown in FIG. 5, the battery pack 50 is coupled between a battery pack terminal V+ and a battery pack terminal V− of the battery pack 50. In one embodiment, the battery pack 50 includes n battery cells coupled in series, where n is an odd number higher than 4. The battery pack 50 includes the 1st battery cell C1, the 2nd battery cell C2, . . . , and the nth battery cell Cn.

In the embodiment of FIG. 5, the battery balancing circuit 51 includes m bridge arms B1-Bm and an inductor L2, where m=(n−1)/2. Each of the m bridge arms B1-Bm includes the high-side switch QH and the low-side switch QL. In other words, there are m high-side switches QH1-QH(n−1)/2 and m low-side switches QL1-QL(n−1)/2. The second terminal of the high-side switch QH is coupled to the first terminal of the low-side switch QL to form the middle node. In each of the m bridge arms B1-Bm, the middle node formed by the high-side switch QH and the low-side switch QL is coupled to a first terminal of the inductor L2.

As shown in FIG. 5, the 1st high-side switch QH1 of the 1st bridge arm B1 is coupled to the anode of the nth battery cell Cn (i.e., the battery pack terminal V+), and the 1st low-side switch QL1 of the 1st bridge arm B1 is coupled to the cathode of the 1st battery cell C1 (i.e., the battery pack terminal V−); the 2nd high-side switch QH2 of the 2nd bridge arm B2 is coupled to the anode of the (n−1)th battery cell Cn−1, and the 2nd low-side switch QL2 of the 2nd bridge arm B2 is coupled to the cathode of the 2nd battery cell C2; . . . ; and the [(n−1)/2]th high-side switch QH(n−1)/2 of the mth bridge arm Bm is coupled to the anode of the {[(n+1)/2]+1}th battery cell C[(n+1)/2]+1, and the [(n−1)/2]th low-side switch QL(n−1)/2 of the mth bridge arm Bm is coupled to the cathode of the {[(n+1)/2]−1}th battery cell C[(n+1)/2]−1. In the embodiment of FIG. 5, the battery balancing circuit 51 further includes a first middle switch Sm1 and a second middle switch Sm2. As shown in FIG. 5, a second terminal of the inductor L2 is configured to be coupled to the anode of the [(n+1)/2]th battery cell C(n+1)/2 through the first middle switch Sm1 and to the cathode of the [(n+1)/2]th battery cell C(n+1)/2 through the second middle switch Sm2. In other words, the second terminal of the inductor L2 is selectively coupled to the anode or cathode of the [(n+1)/2]th battery cell C(n+1)/2 by controlling the first middle switch Sm1 and the second middle switch Sm2.

Similar to the embodiment of FIG. 4, one of the m high-side switch QH1-QH(n−1)/2 and one of the m low-side switch QL1-QL(n−1)/2 could be selected as the pair of operating switches based on the energy transfer demand between the battery cells C1-Cn. The pair of operating switches are turned on and off alternately such that the first terminal of the inductor L2 is coupled to the anode of the first target battery cell or the cathode of the second target battery cell alternately, thereby realizing energy transfer between the battery cells C1-Cn.

In one embodiment, the battery pack 50 includes a first battery group and a second battery group, and the [(n+1)/2]th battery cell C(n+1)/2 is coupled between the first battery group and the second battery group. The first battery group has a first terminal coupled to the battery pack terminal V+, and a second terminal coupled to the anode of the [(n+1)/2]th battery cell C(n+1)/2. The second battery group has a first terminal coupled to the cathode of the [(n+1)/2]th battery cell C(n+1)/2, and a second terminal coupled to the battery pack terminal V−. The first target battery cell is one of the first battery group, and the second target battery is one of the second battery group. In the embodiment of FIG. 5, the first battery group includes (n−1)/2 battery cells from {[(n+1)/2]+1}th battery cell C[(n+1)/2]+1 to the nth battery cell Cn, and the second target battery includes (n−1)/2 battery cells from the 1st battery cell C1 to the {[(n+1)/2]−1}th battery cell C[(n+1)/2]−1. As shown in FIG. 5, the second terminal of the inductor L2 is coupled to the second terminal of the first battery group (i.e., the anode of the [(n+1)/2]th battery cell C(n+1)/2) or the first terminal of the second battery group (i.e., the cathode of the [(n+1)/2]th battery cell C(n+1)/2). In other words, the first middle switch Sm1 is coupled between the second terminal of the inductor L2 and the second terminal of the first battery group, and the second middle switch Sm2 is coupled between the second terminal of the inductor L2 and the first terminal of the second battery group.

In one embodiment, the first target battery cell or the second target battery cell is the battery cell having the highest voltage in the battery pack 50. In another embodiment, the first target battery cell or the second target battery cell is the battery cell having the lowest voltage in the battery pack 50.

In the embodiment of FIG. 5, the battery balancing circuit 51 further includes m−1 high-side blocking switches SH1-SH[(n−1)/2]−1 and m−1 low-side blocking switches SL1-SL[(n−1)/2]−1. The m−1 high-side blocking switches SH1-SH[(n−1)/2]−1 are configured to be coupled in series with the corresponding high-side switches QH of the bridge arms B2-Bm, respectively. The high-side blocking switch SH and the corresponding high-side switch QH are coupled in opposite directions. The m−1 low-side blocking switches SL1-SL[(n−1)/2]−1 are configured to be coupled in series with the corresponding low-side switches QL of the bridge arms B2-Bm, respectively. The low-side blocking switch SL and the corresponding low-side switch QL are coupled in opposite directions.

As shown in FIG. 5, the 2nd high-side switch QH2 of the 2nd bridge arm B2 is coupled to the anode of the (n−1)th battery cell Cn−1 through the 1st high-side blocking switch SH1, the 2nd low-side switch QL2 of the 2nd bridge arm B2 is coupled to the cathode of the 2nd battery cell C2 through the 1st low-side blocking switch SL1; . . . ; and the [(n−1)/2]th high-side switch QH(n−1)/2 of the mth bridge arm Bm is coupled to the anode of the {[(n+1)/2]+1}th battery cell C[(n+1)/2]+1 through the {[(n−1)/2]−1}th high-side blocking switch SH[(n−1)/2]−1, and the [(n−1)/2]th low-side switch QL(n−1)/2 of the mth bridge arm Bm is coupled to the cathode of the {[(n+1)/2]−1}th battery cell C[(n+1)/2]−1 through the {[(n−1)/2]−1}th low-side blocking switch SL[(n−1)/2]−1.

In some embodiments, when the one of the m high-side switches QH is selected as the operating switch, the high-side blocking switch SH coupled in series with the selected high-side switch QH is turned on. When the one of the m low-side switches QL is selected as the operating switch, the low-side blocking switch SL coupled in series with the selected low-side switch QL is turned on.

For example, when the 2nd battery cell C2 is the second target battery cell (i.e., the 2nd battery cell C2 has the highest or the lowest voltage in the battery pack 50), the 2nd low-side switch QL2 is selected as one of the pair of operating switches. Meanwhile, the 1st low-side blocking switch SL1 coupled in series with the 2nd low-side switch QL2 is turned on. Therefore, the first terminal of the inductor L2 could be coupled to the cathode of the 2nd battery cell C2. For another example, when the (n−1)th battery cell Cn−1 is the first target battery cell (i.e., the (n−1)th battery cell Cn−1 has the highest or the lowest voltage in the battery pack 50), the 2nd high-side switch QH2 is selected as one of the pair of operating switches. Meanwhile, the 1st high-side blocking switch SH1 coupled in series with the 2nd high-side switch QH2 is turned on. Therefore, the first terminal of the inductor L2 could be coupled to the anode of the (n−1)th battery cell Cn−1.

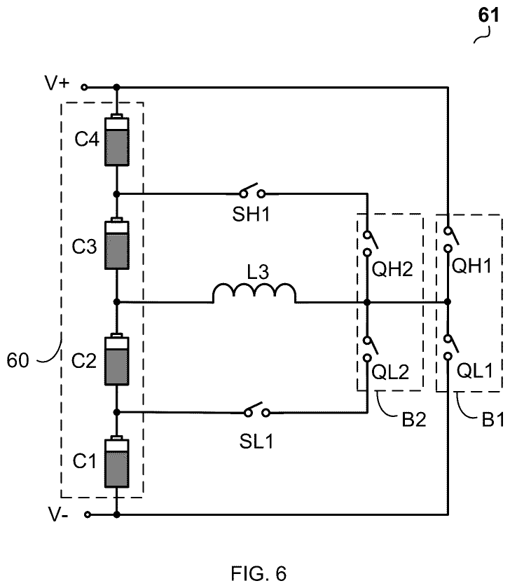

FIG. 6 schematically shows a battery balancing circuit 61 for a battery pack 60 with four battery cells connected in series in accordance with one embodiment of the present disclosure. As shown in FIG. 6, the battery pack 60 includes four battery cells C1-C4 coupled in series (i.e., n=4). The battery balancing circuit 61 includes the 1st bridge arm B1, the 2nd bridge arm B2, and an inductor L3. The 1st bridge arm B1 includes the 1st high-side switch QH1 and the 1st low-side switch QL1 coupled in series. The 2nd bridge arm B2 includes the 2nd high-side switch QH2, and the 2nd low-side switch QL2 coupled in series. The middle node formed by the 1st high-side switch QH1 and the 1st low-side switch QL1 is coupled to a first terminal of the inductor L3. The middle node formed by the 2nd high-side switch QH2 and the 2nd low-side switch QL2 is also coupled to the first terminal of the inductor L3. Meanwhile, a second terminal of the inductor L3 is coupled to the anode of the 2nd battery cell C2.

In the embodiment of FIG. 6, the battery balancing circuit 61 further includes the 1st high-side blocking switch SH1 and the 1st low-side blocking switch SL1. The 1st high-side blocking switch SH1 is coupled in series with the 2nd high-side switch QH2, and the 1st high-side blocking switch SH1 and the 2nd high-side switch QH2 are coupled in opposite directions. The 1st low-side blocking switch SL1 is coupled in series with the 2nd low-side switch QL2, and the 1st low-side blocking switch SL1 and the 2nd low-side switch QL2 are coupled in opposite directions. The 1st high-side switch QH1 of the 1st bridge arm B1 is coupled to the anode of the 4th battery cell C4 (i.e., the battery pack terminal V+), and the 1st low-side switch QL1 is coupled to the cathode of the 1st battery cell C1 (i.e., the battery pack terminal V−). The second high-side switch QH2 of the second bridge arm B2 is coupled to the anode of the 3rd battery cell C3 through the 1st high-side blocking switch SH1, and the 2nd low-side switch QL2 is coupled to the cathode of the 2nd battery cell C2 through the 1st low-side blocking switch SL1.

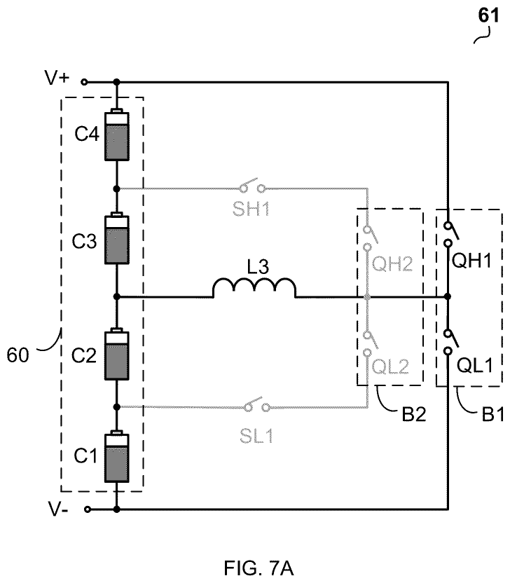

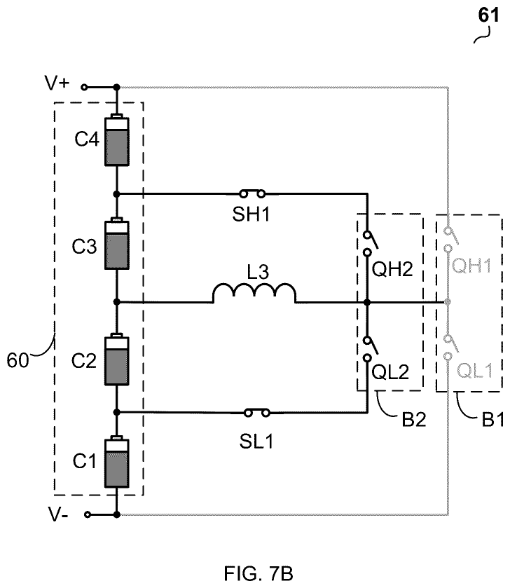

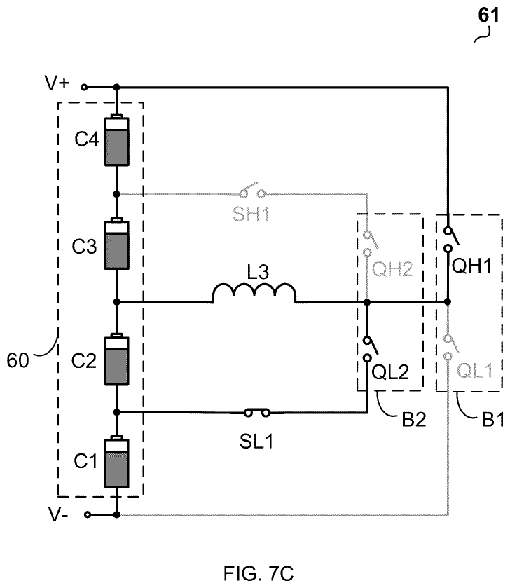

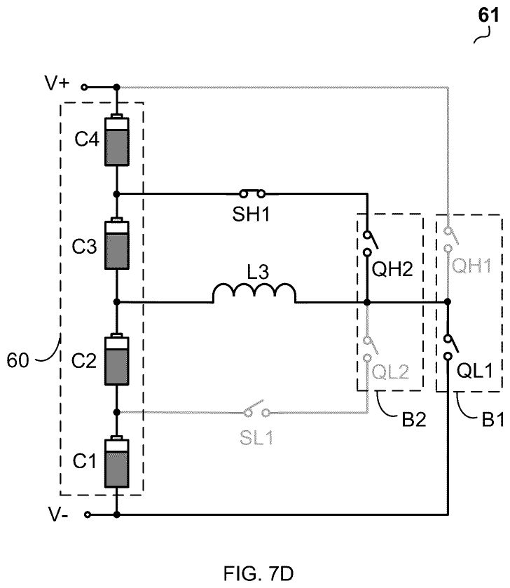

FIG. 7A-7D schematically show the battery balancing circuit 61 shown in FIG. 6 operating in different modes in accordance with one embodiment of the present disclosure. The working principle of the battery balancing circuit 61 is illustrated below with reference to FIGS. 7A-7D.

FIG. 7A schematically shows the battery balancing circuit 61 operating in a first mode in accordance with one embodiment of the present disclosure. When the battery balancing circuit 61 operates in the first mode, the 1st high-side switch QH1 and the 1st low-side switch QL1 of the 1st bridge arm B1 are selected as the pair of operating switches and are turned on/off alternately. The 2nd high-side switch QH2, the 2nd low-side switch QL2, the 1st high-side blocking switch SH1 and the 1st low-side blocking switch SL1 are turned off. In some embodiments, firstly, the 1st high-side switch QH1 is turned on and the 1st low-side switch QL1 is turned off. The 1st high-side switch QH1, the inductor L3 and the battery cells C3-C4 form a discharge loop.

In other words, the inductor L3 stores the energy discharged from the battery cells C3-C4. Subsequently, the 1st high-side switch QH1 is turned off and the 1st low-side switch QL1 is turned on. The 1st low-side switch QL1, the battery cells C1-C2 and the inductor L3 form a charge loop. In other words, the inductor L3 transfers the stored energy to charge the battery cells C1-C2. In some other embodiments, firstly, the 1st low-side switch QL1 is turned on and the 1st high-side switch QH1 is turned off, the inductor L3 stores the energy discharged from the battery cells C1-C2. Subsequently, the 1st low-side switch QL1 is turned off and the 1st high-side switch QH1 is turned on, the inductor L3 transfers the stored energy to charge the battery cells C3-C4. Therefore, when the battery balancing circuit 61 operates in the first mode, energy transfer between the battery cells C1-C2 and the battery cells C3-C4 could be realized by turning on/off the 1st high-side switch QH1 and the 1st low-side switch QL1 alternately.

FIG. 7B schematically shows the battery balancing circuit 61 operating in a second mode in accordance with one embodiment of the present disclosure. When the battery balancing circuit 61 operates in the second mode, the 2nd high-side switch QH2 and the 2nd low-side switch QL2 of the 2nd bridge arm B2 are selected as the pair of operating switches and are turned on/off alternately. The 1st high-side switch QH1 and the 1st low-side switch QL1 is turned off. The 1st high-side blocking switch SH1 and the 1st low-side blocking switch SL1 are turned on. In some embodiments, firstly, the 2nd high-side switch QH2 is turned on and the 2nd low-side switch QL2 is turned off. The 2nd high-side switch QH2, the inductor L3 and the 3rd battery cell C3 form a discharge loop. In other words, the inductor L3 stores the energy discharged from the 3rd battery cell C3. Subsequently, the 2nd high-side switch QH2 is turned off and the 2nd low-side switch QL2 is turned on. The 2nd low-side switch QL2, the 2nd battery cell C2 and the inductor L3 form a charge loop. In other words, the inductor L3 transfers the stored energy to charge the 2nd battery cell C2. In some other embodiments, firstly, the 2nd low-side switch QL2 is turned on and the 2nd high-side switch QH2 is turned off, the inductor L3 stores the energy discharged from the 2nd battery cell C2. Subsequently, the 2nd low-side switch QL2 is turned off and the 2nd high-side switch QH2 is turned on, the inductor L3 transfers the stored energy to charge the 3rd battery cell C3. Therefore, when the battery balancing circuit 61 operates in the second mode, energy transfer between the 2nd battery cell C2 and the 3rd battery cell C3 could be realized by turning on/off the 2nd high-side switch QH2 and the 2nd low-side switch QL2 alternately.

FIG. 7C schematically shows the battery balancing circuit 61 operating in a third mode in accordance with one embodiment of the present disclosure. When the battery balancing circuit 61 operates in the third mode, the 1st high-side switch QH1 of the 1st bridge arm B1 and the 2nd low-side switch QL2 of the 2nd bridge arm B2 are selected as the pair of operating switches and are turned on/off alternately. The 1st low-side blocking switch SL1 is turned on. The 1st low-side switch QL1, the 2nd high-side switch QH2 and the 1st high-side blocking switch SH1 are turned off. In some embodiments, firstly, the 1st high-side switch QH1 is turned on and the 2nd low-side switch QL2 is turned off. The 1st high-side switch QH1, the inductor L3 and the battery cells C3-C4 form a discharge loop. In other words, the inductor L3 stores the energy discharged from the battery cells C3-C4. Subsequently, the 1st high-side switch QH2 is turned off and the 2nd low-side switch QL2 is turned on. The 2nd low-side switch QL2, the 2nd battery cell C2 and the inductor L3 form a charge loop. In other words, the inductor L3 transfers the stored energy to charge the 2nd battery cell C2. In some other embodiments, firstly, the 2nd low-side switch QL2 is turned on and the 1st high-side switch QH1 is turned off, the inductor L3 stores the energy discharged from the 2nd battery cell C2. Subsequently, the 2nd low-side switch QL2 is turned off and the 1st high-side switch QH1 is turned on, the inductor L3 transfers the stored energy to charge the battery cells C3-C4. Therefore, when the battery balancing circuit 61 operates in the third mode, energy transfer between the 2nd battery cells C2 and the battery cells C3-C4 could be realized by turning on/off the 1st high-side switch QH1 and the 2nd low-side switch QL2 alternately.

FIG. 7D schematically shows the battery balancing circuit 61 operating in a fourth mode in accordance with one embodiment of the present disclosure. When the battery balancing circuit 61 operates in the fourth mode, the 1st low-side switch QL1 of the 1st bridge arm B1 and the 2nd high-side switch QH2 of the 2nd bridge arm B2 are selected as the pair of operating switches and are turned on/off alternately. The 1st high-side blocking switch SH1 is turned on. The 1st high-side switch QH1, the 2nd low-side switch QL2 and the 1st low-side blocking switch SL1 are turned off. In some embodiments, firstly, the 2nd high-side switch QH2 is turned on and the 1st low-side switch QL1 is turned off. The 2nd high-side switch QH2, the inductor L3 and the 3rd battery cell C3 form a discharge loop. In other words, the inductor L3 stores the energy discharged from the 3rd battery cell C3. Subsequently, the 2nd high-side switch QH2 is turned off and the 1st low-side switch QL1 is turned on. The 1st low-side switch QL1, the battery cells C1-C2 and the inductor L3 form a charge loop. In other words, the inductor L3 transfers the stored energy to charge the battery cells C1-C2. In some other embodiments, firstly, the 1st low-side switch QL1 is turned on and the 2nd high-side switch QH2 is turned off, the inductor L3 stores the energy discharged from the battery cells C1-C2. Subsequently, the 1st low-side switch QL1 is turned off and the 2nd high-side switch QH2 is turned on, the inductor L3 transfers the stored energy to charge the 3rd battery cell C3. Therefore, when the battery balancing circuit 61 operates in the third mode, energy transfer between the battery cells C1-C2 and the 3rd battery cell C3 could be realized by turning on/off the 2nd high-side switch QH2 and the 1st low-side switch QL1 alternately.

Table 1 below shows energy transfer between the battery cells C1-C4 when the battery balancing circuit 61 of the battery pack 60 operates in different modes in accordance with one embodiment of the present disclosure.

TABLE 1

| | |
|---|---|
| First Mode | C1 + C2 ↔ C3 + C4 |
| Second Mode | C2 ↔ C3 |
| Third Mode | C2 ↔ C3 + C4 |
| Fourth Mode | C1 + C2 ↔ C3 |

In the embodiments of the present disclosure, the battery balancing circuits select one of the high-side switches and one of the low-side switches as the pair of operating switches based on the battery cell(s) with the highest and/or lowest voltage in the battery pack. The energy transfer between the battery cells could be realized by alternately turning on/off the pair of operating switches, thereby balancing the voltages of the battery cells to a target average voltage. Therefore, the battery balancing circuits provided by the embodiments of the present disclosure have advantages of simple structure, low cost, and better balancing efficiency.

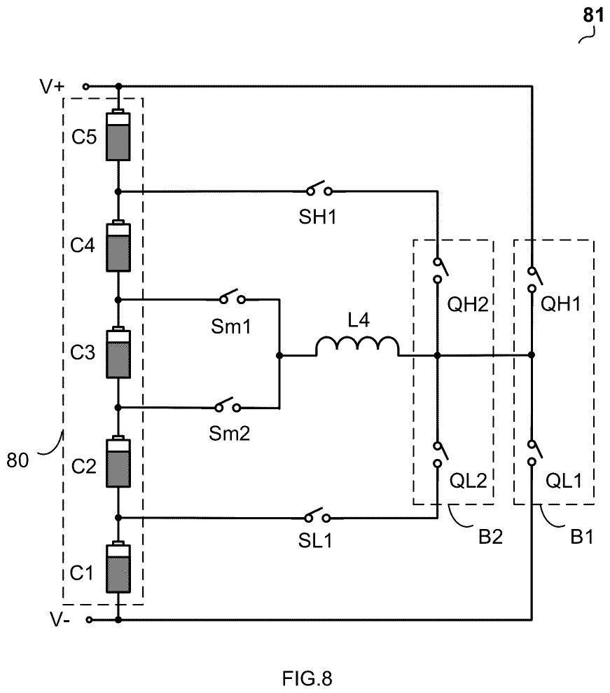

FIG. 8 schematically shows a battery balancing circuit 81 for a battery pack 80 with five battery cells in accordance with one embodiment of the present disclosure. As shown in FIG. 8, the battery pack 80 includes five battery cells C1-C5 coupled in series (i.e., n=5). The battery balancing circuit 81 includes the 1st bridge arm B1, the 2nd bridge arm B2, and an inductor L4. The 1st bridge arm B1 includes the 1st high-side switch QH1 and the 1st low-side switch QL1 coupled in series. The 2nd bridge arm B2 includes the 2nd high-side switch QH2 and the 2nd low-side switch QL2 coupled in series. The middle node formed by the 1st high-side switch QH1 and the 1st low-side switch QL1 is coupled to a first terminal of the inductor L4. The middle node formed by the 2nd high-side switch QH2 and the 2nd low-side switch QL2 is also coupled to the first terminal of the inductor L4.

In the embodiment of FIG. 8, the battery balancing circuit 81 further includes the 1st high-side blocking switch SH1 and the 1st low-side blocking switch SL1. The 1st high-side blocking switch SH1 is coupled in series with the 2nd high-side switch QH2, and the 1st high-side blocking switch SH1 and the 2nd high-side switch QH2 are coupled in opposite directions. The 1st low-side blocking switch SL1 is coupled in series with the 2nd low-side switch QL2, and the 1st low-side blocking switch SL1 and the 2nd low-side switch QL2 are coupled in opposite directions The 1st high-side switch QH1 of the 1st bridge arm B1 is coupled to the anode of the 5th battery cell C5 (i.e., the battery pack terminal V+), and the 1st low-side switch QL1 is coupled to the cathode of the 1st battery cell C1 (i.e., the battery pack terminal V−). The 2nd high-side switch QH2 of the 2nd bridge arm B2 is coupled to the anode of the 4th battery cell C4 through the 1st high-side blocking switch SH1, and the 2nd low-side switch QL2 is coupled to the cathode of the 2nd battery cell C2 through the 1st low-side blocking switch SL1. In the embodiments of FIG. 8, a second terminal of the inductor L4 is coupled to the anode of the 3rd battery cell C3 through the first middle switch Sm1 and to the cathode of the 3rd battery cell C3 through the second middle switch Sm2. In other words, the second terminal of the inductor L4 is selectively coupled to the anode or cathode of the 3rd battery cell C3 based on the energy transfer demand of the battery pack 80.

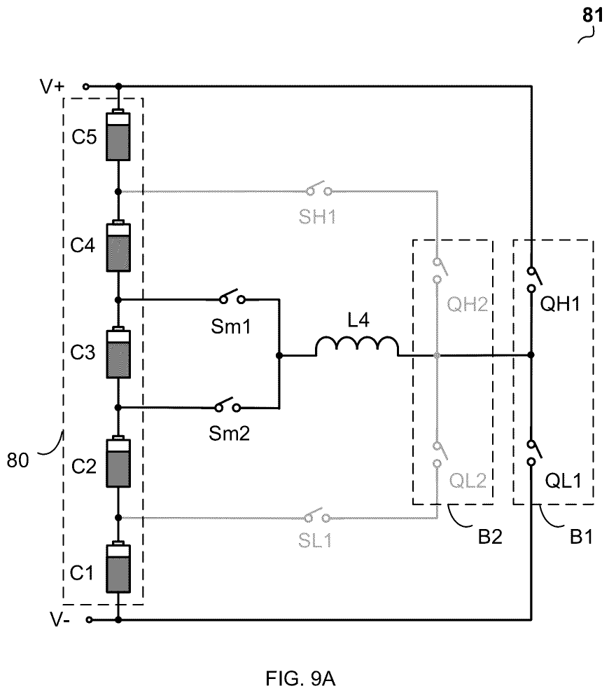

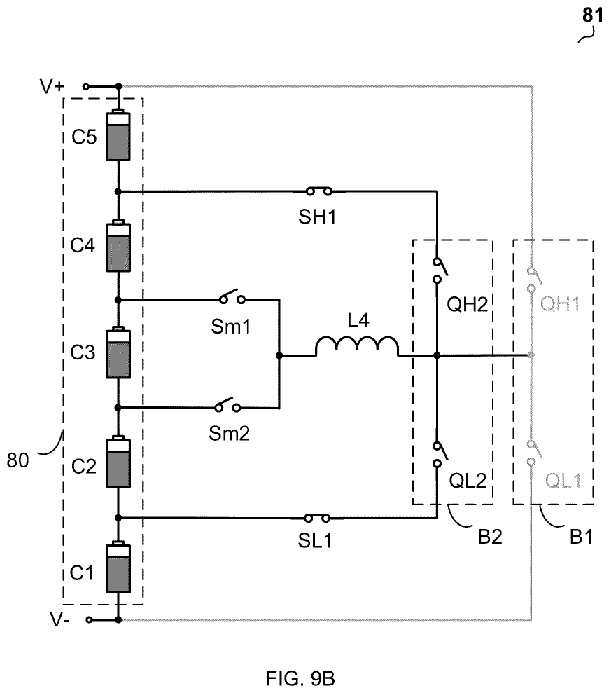

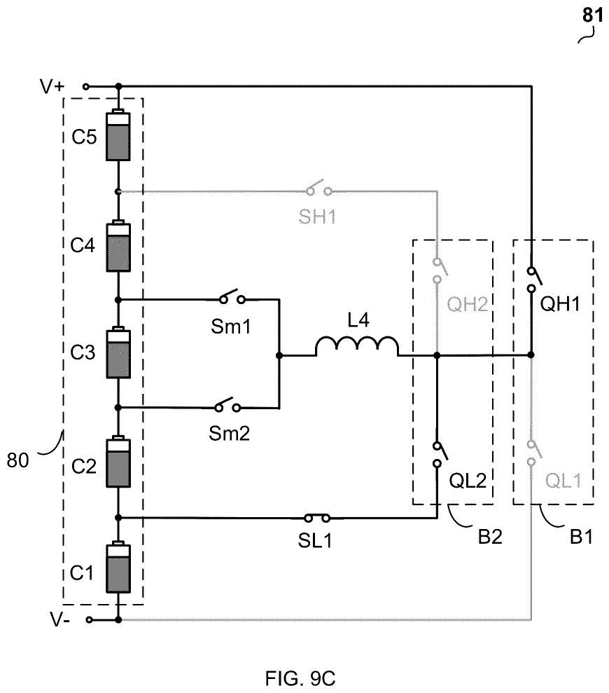

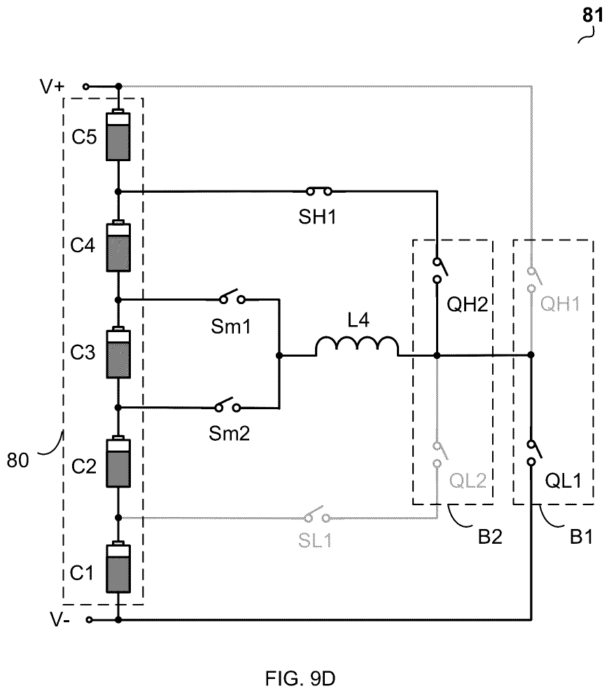

Similar to the battery balancing circuit 61 shown in FIG. 6, the battery balancing circuit 81 also could operate in different modes. FIGS. 9A-9D schematically show the battery balancing circuit 81 operating in different modes in accordance with one embodiment of the present disclosure. The working principle of the battery balancing circuit 81 is illustrated below with reference to FIGS. 9A-9D.

As shown in FIG. 9A, when the battery balancing circuit 81 operates in the first mode, the 1st high-side switch QH1 and the 1st low-side switch QL1 of the 1st bridge arm B1 are selected as the pair of operating switches and are turned on/off alternately. The 2nd high-side switch QH2 and the 2nd low-side switch QL2 of the 2nd bridge arm B2 as well as the 1st high-side blocking switch SH1 and the 1st low-side blocking switch SL1 are turned off.

As shown in FIG. 9B, when the battery balancing circuit 81 operates in the second mode, the 2nd high-side switch QH2 and the 2nd low-side switch QL2 of the 2nd bridge arm B2 are selected as the pair of operating switches and are turned on/off alternately. Meanwhile, the 1st high-side blocking switch SH1 and the 1st low-side blocking switch SL1 are turned on, and the 1st high-side switch QH1 and the 1st low-side switch QL1 of the 1st bridge arm B1 is turned off.

As shown in FIG. 9C, when the battery balancing circuit 81 operates in the third mode, the 1st high-side switch QH1 of the 1st bridge arm B1 and the 2nd low-side switch QL2 of the 2nd bridge arm B2 are selected as the pair of operating switches and are turned on/off alternately. Meanwhile, the 1st low-side blocking switch SL1 keeps on, and the 1st low-side switch QL1, the 2nd high-side switch QH2 and the 1st high-side blocking switch SH1 are turned off.

As shown in FIG. 9D, when the battery balancing circuit 81 operates in the fourth mode, the 1st low-side switch QL1 of the 1st bridge arm B1 and the 2nd high-side switch QH2 of the 2nd bridge arm B2 are selected as the pair of operating switches and are turned on/off alternately. Meanwhile, the 1st high-side blocking switch SH1 is turned on, and the 1st high-side switch QH1, the 2nd low-side switch QL2 and the 1st low-side blocking switch SL1 are turned off.

It should be appreciated that, when the battery balancing circuit 81 operates in one of the aforementioned modes, the first middle switch Sm1 and the second middle switch Sm2 could be selectively turned on based on the energy transfer demand of the battery pack 80. In other words, the second terminal of the inductor L4 could be selectively coupled to the anode or cathode of the 3rd battery cell C3 based on the energy transfer demand of the battery pack 80.

For example, in one embodiment, the battery balancing circuit 81 operates in the second mode, firstly, the second terminal of the inductor L4 is coupled to the cathode of the 3rd battery cell C3 (i.e., the second middle switch Sm2 is turned on) and the 2nd low-side switch QL2 is turned on. The 2nd battery cell C2, the inductor L4 and the 2nd low-side switch QL2 and the 1st low-side blocking switch SL1 form a discharge loop. The inductor L4 stores the energy discharged from the 2nd battery cell C2. Subsequently, the second terminal of the inductor L4 is coupled to the anode of 3rd battery cell C3 (i.e., the first middle switch Sm1 is turned on), the 2nd low-side switch QL2 is turned off and the 2nd high-side switch QH2 is turned on. The 4th battery cell C4, the inductor L4, the 2nd high-side switch QH2 and the 1st high-side blocking switch SH1 form a charge circuit. The inductor L4 transfers the stored energy to charge the 4th battery cell C4. Therefore, energy transfer between the 2nd battery cell C2 and the 4th battery cell C4 could be realized.

Table 2 below shows energy transfer between the battery cells C1-C5 when the battery balancing circuit 81 of the battery pack 80 operates in different modes in accordance with one embodiment of the present disclosure.

TABLE 2

| | |
|---|---|
| First Mode | C1 + C2 + C3 ↔ C4 + C5 |
| | C1 + C2 ↔ C3 + C4 + C5 |
| | C1 + C2 ↔ C4 + C5 |
| Second Mode | C2 + C3 ↔ C4 |
| | C2 ↔ C3 + C4 |
| | C2 ↔ C4 |
| Third Mode | C2 + C3 ↔ C4 + C5 |
| | C2 ↔ C3 + C4 + C5 |
| | C2 ↔ C4 + C5 |
| Fourth Mode | C1 + C2 + C3 ↔ C4 |
| | C1 + C2 ↔ C3 + C4 |
| | C1 + C2 ↔ C4 |

The working principle of the battery balancing circuit 81 is similar to the battery balancing circuit 61 and detailed descriptions thereof are omitted here.

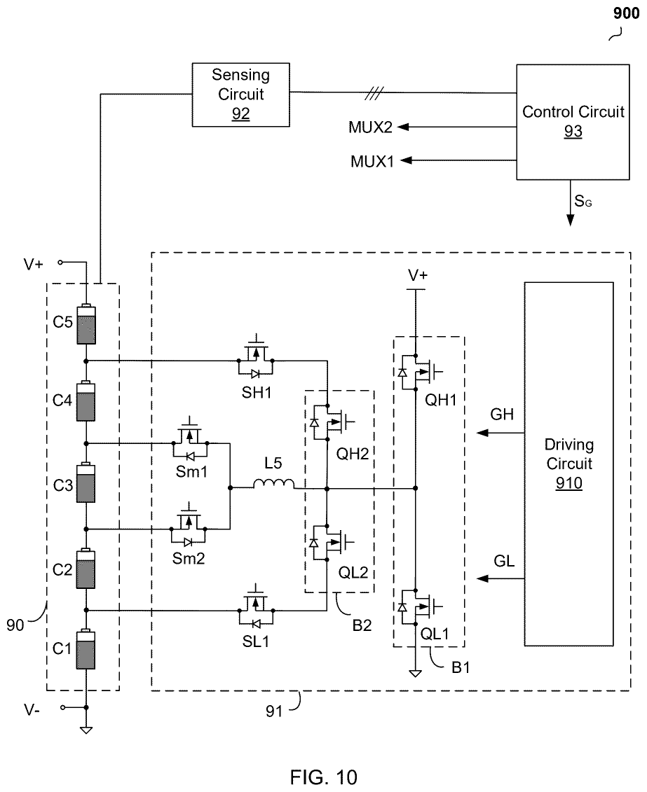

FIG. 10 schematically shows a battery balancing system 900 in accordance with one embodiment of the present disclosure. As shown in FIG. 10, the battery balancing system 900 includes a battery pack 90, a battery balancing circuit 91, a sensing circuit 92 and a control circuit 93. The battery pack 90 is coupled between the battery pack terminals V+ and V−. In one embodiment, the battery pack 90 includes n battery cells coupled in series, where n is an integer greater than or equal to 4. The battery pack 90 includes the 1st battery cell C1, the 2nd battery cell C2, . . . , and the nth battery cell Cn. The sensing circuit 92 is configured to be coupled to each battery cell in the battery pack 90 for sensing the voltage of each battery cell, and to provide sensing data. The control circuit 93 is configured to receive the sensing data provided by the sensing circuit 92 and monitor the status of each battery cell in the battery pack 90. In one embodiment, based on the sensing data and the monitor status, the control circuit 93 determines a target battery cell and manages the charge and discharge process of the battery cells for balancing the battery pack 90. For instance, the control circuit 93 controls the battery balancing circuit 91, and the battery balancing circuit 91 balances the battery pack 90, and therefore the energy of the battery cell with a relatively high voltage is transferred to the battery cell with a relatively low voltage.

In one embodiment, the target battery cell is the battery cell having the highest cell voltage in the battery pack 90. In another embodiment, the target battery cell is the battery cell having the lowest voltage in the battery pack 90. In some embodiments, the target battery cell is the battery cell whose voltage is lower than the average voltage of the battery pack 90. In some other embodiments, the target battery cell is the battery cell whose voltage is higher than the average voltage of the battery pack 90.

In some embodiments, the control circuit 93 controls the battery balancing circuit 91 to manage and balance the battery cells based on the status of the target battery cell. For instance, the control circuit 93 is configured to calculate the average voltage of the battery pack 90, and to obtain a difference between the voltage of the target battery cell and the average voltage. If the difference is higher than a predetermined threshold voltage, the control circuit 93 starts to manage and balance the battery cells.

As shown in FIG. 10 the battery pack 90 includes five battery cells C1-C5 coupled in series. The battery balancing circuit 91 includes the 1st bridge arm B1, the 2nd bridge arm B2 and an inductor L5. The 1st bridge arm B1 includes the 1st high-side switch QH1 and the 1st low-side switch QL1 coupled in series. The 2nd bridge arm B2 includes the 2nd high-side switch QH2 and the 2nd low-side switch QL2 coupled in series. The 1st high-side switch QH1 of the 1st bridge arm B1 is coupled to the anode of the 5th battery cell C5 (i.e., the battery pack terminal V+), and the 1st low-side switch QL1 is coupled to the cathode of the 1st battery cell C1 (i.e., the battery pack terminal V−). The 2nd high-side switch QH2 of the 2nd bridge arm B2 is coupled to the anode of the 4th battery cell C4, and the 2nd low-side switch QL2 is coupled to the cathode of the 2nd battery cell C2. The middle node formed by the 1st high-side switch QH1 and the 1st low-side switch QL1 is coupled to a first terminal of the inductor L5. The middle node formed by the 2nd high-side switch QH2 and the 2nd low-side switch QL2 is coupled to the first terminal of the inductor L5.

In the embodiment of FIG. 10, the battery balancing circuit 91 further includes the 1st high-side blocking switch SH1 and the 1st low-side blocking switch SL1. The 1st high-side blocking switch SH1 is coupled in series with the 2nd high-side switch QH2, and 1st high-side blocking switch SH1 and the 2nd high-side switch QH2 are coupled in opposite directions. The 1st low-side blocking switch SL1 is coupled in series with the 2nd low-side switch QL2, and 1st low-side blocking switch SL1 and the 2nd low-side switch QL2 are coupled in opposite directions. The 2nd high-side switch QH2 of the 2nd bridge arm B2 is coupled to the anode of the 4th battery cell C4 through the 1st high-side blocking switch SH1, and the 2nd low-side switch QL2 is coupled to the cathode of the 2nd battery cell C2 through the 1st low-side blocking switch SL1. In one embodiment, when the 2nd high-side switch QH2 is selected as one of the pair of operating switches, the 1st high-side blocking switch SH1 is turned on. In another embodiment, when the 2nd low-side switch QL2 is selected as one of the pair of operating switches, the 1st low-side blocking switch SL1 is turned on.

In the embodiment of FIG. 10, the battery balancing circuit 91 further includes the first middle switch Sm1 and the second middle switch Sm2. A second terminal of the inductor L5 is selectively coupled to the anode or the cathode of the 3rd battery cell C3 through the first middle switch Sm1 and the second middle switch Sm2. It should be appreciated that, when n is an even number, the second terminal of the inductor L5 could be directly coupled to the anode of the (n/2)th battery cell Cn/2. In other words, when n is the even number, the first middle switch Sm1 and the second middle switch Sm2 could be omitted.

In the embodiment of FIG. 10, when the control circuit 93 manages and balances the battery cells C1-C5, one of the 1st high-side switch QH1 and the 2nd high-side switch QH2 and one of the 1st low-side switch QL1 and the 2nd low-side switch QL2 are selected as a pair of operating switches. The pair of operating switches are turned on and off alternately such that the charge and discharge process of the target battery cell could be performed by alternately coupling the first terminal of the inductor L5 to the anode or the cathode of the target battery cell.

In the embodiment of FIG. 10, the battery balancing circuit 91 further includes a driving circuit 910. When the control circuit 93 manages and balances the battery cells C1-C5, the control circuit 93 is configured to provide a switch control signal SG to the driving circuit 910. The driving circuit 910 is configured to provide a high-side driving signal GH and a low-side driving signal GL in response to the switch control signal SG. The high-side driving signal GH is configured to control the high-side switch QH of the pair of operating switches. The low-side driving signal GL is configured to control the low-side switch QL of the pair of operating switches. The pair of operating switches are turned on and off alternately under the control of the high-side driving signal GH and the low-side driving signal GL. At the same time, the control circuit 93 is configured to provide a first control signal MUX1 and a second control signal MUX2. When one of the high-side switches QH and one of the low-side switches QL are selected as the pair of operating switches, the first control signal MUX1 is configured to turn on the high-side blocking switch SH coupled in series with the selected high-side switch QH and the low-side blocking switch SL coupled in series with the selected low-side switch QL. The second control signal MUX2 is configured to selectively turn on the first middle switch Sm1 and the second middle switch Sm2. It should be understood that the second control signal MUX2 may not be required when n is the even number.

In some embodiments, when the charge and discharge process of the target battery cell is completed, the average voltage of the battery pack 90 is calculated again. When the difference between the voltage of the target battery cell and the average voltage is less than the predetermined threshold voltage, the manage and balancing operation of the control circuit 93 is finished. Accordingly, the control circuit 93 stops providing the switch control signal SG, the first control signal MUX1 and the second control signal MUX2.

In the embodiment of FIG. 10, the switches QH, QL, SH, SL and Sm are N-MOSFETs. It should be appreciated that, other suitable switches could be applied in the present disclosure, for example, insulated gate bipolar transistors (IGBTs).

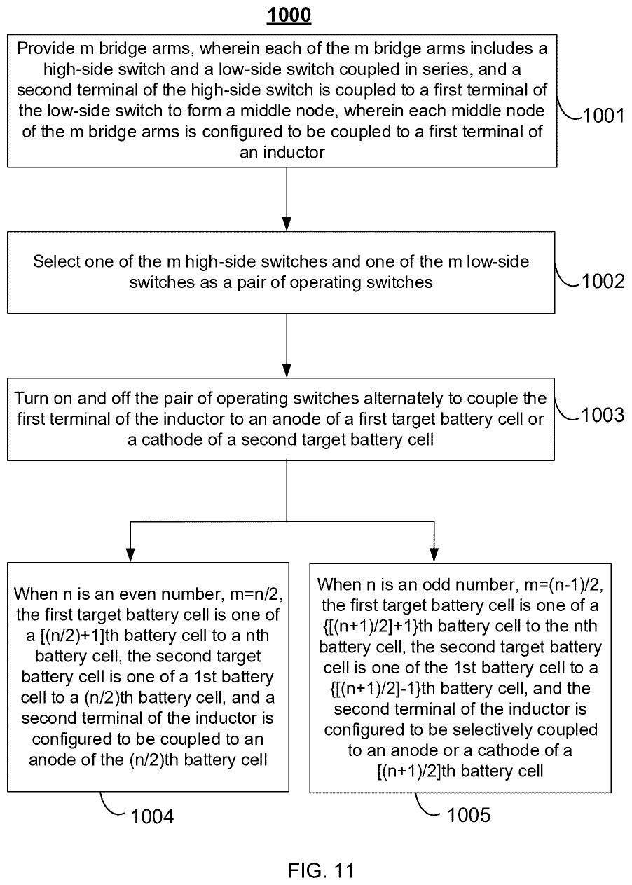

FIG. 11 shows a flowchart of a method 1000 for balancing a battery pack in accordance with one embodiment of the present disclosure. The battery pack includes the 1st battery cell, the 2nd battery cell, . . . , and the nth battery cell, where n is an integer equal to or greater than 4. The method 1000 includes actions 1001-1005.

In action 1001, m bridge arms are provided. Each of the m bridge arms includes a high-side switch and a low-side switch coupled in series. A second terminal of the high-side switch is coupled to a first terminal of the low-side switch to form a middle node, and each middle node of the m bridge arms is coupled to a first terminal of an inductor.

In action 1002, one of the m high-side switches and one of the m low-side switches are selected as a pair of operating switches.

In action 1003, the pair of operating switches is turned on and off alternately to couple the first terminal of the inductor to the anode of a first target battery cell or the cathode of a second target battery cell.

In action 1004, when n is an even number, m=n/2, the first target battery cell is one of the [(n/2)+1]th battery cell to the nth battery cell, and the second target battery cell is one of the 1st battery cell to the (n/2)th battery cell, and a second terminal of the inductor is coupled to the anode of the (n/2)th battery cell.

In action 1005, when n is an odd number, m= (n−1)/2, the first target battery cell is one of the {[(n+1)/2]+1}th battery cell to the nth battery cell, and the second target battery cell is one of the 1st battery cell to the {[(n+1)/2]−1}th battery cell, and a second terminal of the inductor is selectively coupled to the anode or the cathode of the [(n+1)/2]th battery cell.

In one embodiment, the first target battery cell or the second target battery cell is a battery cell having the highest voltage in the battery pack. In another embodiment, the first target battery cell or the second target battery cell is a battery cell having the lowest voltage in the battery pack.

In one embodiment, the m bridge arms include the 1st bridge arm, the 2nd bridge arm, . . . , and the nth bridge arm. The 1st bridge arm is coupled between the anode of the nth battery cell and the cathode of the 1st battery cell. The 2nd bridge arm is coupled between the anode of the (n−1)th battery cell and the cathode of the 2nd battery cell. When the n is the even number, the nth bridge arm is coupled between the anode of the [(n/2)+1]th battery cell and the cathode of the (n/2) battery cell. When the n is the odd number, the nth bridge arm is coupled between the anode of the {[(n+1)/2]+1}th battery cell and the cathode of {[(n+1)/2]−1}th battery cell.

In one embodiment, m−1 high-side blocking switches are configured to be coupled in series with the corresponding high-side switches from the 2nd bridge arm to the mth bridge arm, respectively. The high-side blocking switch and the corresponding high-side switch are coupled in opposite directions. In one embodiment, m−1 low-side blocking switches are configured to be coupled in series with the corresponding low-side switches from the 2nd bridge arm to the mth bridge arm, respectively. The low-side blocking switch and the corresponding low-side switch are coupled in opposite directions.

Although the flowchart of FIG. 11 shows a sequential action, it is obvious to persons skilled the art that the method 1000 illustrated above could be performed in different orders.

In the present invention, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Obviously, many modifications and variations of the present invention are possible in light of the above teachings. It is therefore to be understood that within the scope of the appended claims the invention may be practiced otherwise than as specifically described. It should be understood, of course, the foregoing disclosure relates only to a preferred embodiment (or embodiments) of the invention and that numerous modifications may be made therein without departing from the spirit and the scope of the invention as set forth in the appended claims. Various modifications are contemplated, and they obviously will be resorted to by those skilled in the art without departing from the spirit and the scope of the invention as hereinafter defined by the appended claims as only a preferred embodiment(s) thereof has been disclosed.

What is claimed is:

1. A battery balancing circuit for a battery pack with n battery cells connected in series, the battery balancing circuit comprising:
m bridge arms, wherein each of the m bridge arms comprises a high-side switch and a low-side switch coupled in series, a second terminal of the high-side switch is coupled to a first terminal of the low-side switch to form a middle node,
wherein each middle node of the m bridge arms is configured to be coupled to a first terminal of an inductor, and
wherein one of the m high-side switches and one of the m low-side switches are operable to be selected as a pair of operating switches, and alternately turned on and off to couple the first terminal of the inductor to an anode of a first target battery cell from a first battery group of the battery pack and a cathode of a second target battery cell from a second battery group of the battery pack.

2. The battery balancing circuit of claim 1, wherein:
when n is an even number, m=n/2, the first battery group has n/2 battery cells from a [(n/2)+1]th battery cell to a nth battery cell, and the second battery group has n/2 battery cells from a 1st battery cell to a (n/2)th battery cell.

3. The battery balancing circuit of claim 1, wherein:
when n is an odd number, m= (n−1)/2, the first battery group has (n−1)/2 battery cells from a {[(n+1)/2]+1}th battery cell to a nth battery cell, and the second battery group has (n−1)/2 battery cells from a 1st battery cell to a {[(n+1)/2]−1}th battery cell.

4. The battery balancing circuit of claim 1, wherein:
the first target battery cell or the second target battery cell is a battery cell having a highest voltage in the battery pack.

5. The battery balancing circuit of claim 1, wherein:
the first target battery cell or the second target battery cell is a battery cell having a lowest voltage in the battery pack.

6. The battery balancing circuit of claim 1, wherein:
a 1st bridge arm of the m bridge arms is configured to be coupled between an anode of a nth battery cell and a cathode of a 1st battery cell;
a 2nd bridge arm of the m bridge arms is configured to be coupled between an anode of a (n−1)th battery cell and a cathode of a 2nd battery cell; and wherein
if n is an even number, a mth bridge arm of the m bridge arms is configured to be coupled between an anode of a [(n/2)+1]th battery cell and a cathode of a (n/2)th battery cell; and
if n is an odd number, the mth bridge arm of the m bridge arms is configured to be coupled between an anode of a {[(n+1)/2]+1}th battery cell and a cathode of a {[(n+1)/2]−1}th battery cell.

7. The battery balancing circuit of claim 6, further comprising:
m−1 high-side blocking switches, wherein the m−1 high-side blocking switches are coupled in series with a corresponding high-side switch from the 2nd bridge arm to the mth bridge arm, respectively; and
m−1 low-side blocking switches, wherein the m−1 low-side blocking switches are coupled in series with a corresponding low-side switch from the 2nd bridge arm to the mth bridge arm, respectively.

8. The battery balancing circuit of claim 7, wherein:
when one of the m high-side switches is selected as the operating switch, the high-side blocking switch coupled in series with the selected high-side switch is turned on; and
when one of the m low-side switches is selected as the operating switch, the low-side blocking switch coupled in series with the selected low-side switch is turned on.

9. The battery balancing circuit of claim 6, wherein:
when the battery balancing circuit operates in a first mode, a 1st high-side switch of the 1st bridge arm and a 1st low-side switch of the 1st bridge arm are selected as the pair of operating switches and configured to be turned on and off alternately;
when the battery balancing circuit operates in a second mode, a 2nd high-side switch of the 2nd bridge arm and a 2nd low-side switch of the 2nd bridge arm are selected as the pair of operating switches and configured to be turned on and off alternately;
when the battery balancing circuit operates in a third mode, the 1st high-side switch of the 1st bridge arm and the 2nd low-side switch of the 2nd bridge arm are selected as the pair of operating switches and configured to be turned on and off alternately; and
when the battery balancing circuit operates in a fourth mode, the 1st low-side switch of the 1st bridge arm and the 2nd high-side switch of the 2nd bridge arm are selected as the pair of operating switches and configured to be turned on and off alternately.

10. The battery balancing circuit of claim 9, wherein when n=4:
in the first mode, the battery balancing circuit is operable to transfer energy between a combination of the 1st battery cell and the 2nd battery cell and a combination of a 3rd battery cell and a 4th battery cell;
in the second mode, the battery balancing circuit is operable to transfer energy between the 2nd battery cell and the 3rd battery cell;
in the third mode, the battery balancing circuit is operable to transfer energy between the 2nd battery cell and the combination of the 3rd battery cell and the 4th battery cell; and
in the fourth mode, the battery balancing circuit is operable to transfer energy between the 3th battery cell and the combination of the 1st battery cell and the 2nd battery cell.

11. The battery balancing circuit of claim 9, wherein when n=5:
in the first mode, the battery balancing circuit is operable to transfer energy between: (i) a combination of the 1st battery cell, the 2nd battery cell and a 3rd battery cell and a combination of a 4th battery cell and a 5th battery cell; (ii) a combination of the 1st battery cell and the 2nd battery cell and a combination of the 3rd battery cell, the 4th battery cell and the 5th battery cell; and (iii) a combination of the 1st battery cell and the 2nd battery cell and a combination of the 4th battery cell and the 5th battery cell;
in the second mode, the battery balancing circuit is operable to transfer energy between: (i) the 4th battery cell and a combination of the 2nd battery cell and the 3rd battery cell; (ii) the 2nd battery cell and a combination of the 3rd battery cell and the 4th battery cell; and (iii) the 2nd battery cell and the 4th battery cell;
in the third mode, the battery balancing circuit is operable to transfer energy between: (i) the combination of the 2nd battery cell and the 3rd battery cell and the combination of the 4th battery cell and the 5th battery cell; (ii) the 2nd battery cell and the combination of the 3rd battery cell, the 4th battery cell and the 5th battery cell; and (iii) the 2nd battery cell and the combination of the 4th battery cell and the 5th battery cell; and
in the fourth mode, the battery balancing circuit is operable to transfer energy between: (i) the 4th battery cell and the combination of the 1st battery cell, the 2nd battery cell and the 3rd battery cell; (ii) the combination of the 1st battery cell and the 2nd battery cell and the combination of the 3rd battery cell and the 4th battery cell; and (iii) the 4th battery cell and the combination of the 1st battery cell and the 2nd battery cell.

12. The battery balancing circuit of claim 1, wherein when n is an odd number, the battery balancing circuit further comprises:
a first middle switch configured to be coupled between a second terminal of the inductor and a second terminal of the first battery group; and
a second middle switch configured to be coupled between the second terminal of the inductor and a first terminal of the second battery group.

13. A battery balancing system, comprising:
a battery pack having n battery cells connected in series; and
a battery balancing circuit, comprising:
m bridge arms, wherein each of the m bridge arms comprises a high-side switch and a low-side switch coupled in series, a second terminal of the high-side switch is coupled to a first terminal of the low-side switch to form a middle node, wherein each middle node of the m bridge arms is configured to be coupled to a first terminal of an inductor, and wherein one of the m high-side switches and one of the m low-side switches are operable to be selected as a pair of operating switches, and alternately turned on and off to couple the first terminal of the inductor to an anode of a first target battery cell and a cathode of a second target battery cell; and wherein
when n is an even number, m=n/2, the first target battery cell is one of a [(n/2)+1]th battery cell to a nth battery cell, the second target battery cell is one of a 1st battery cell to a (n/2)th battery cell, and a second terminal of the inductor is configured to be coupled to an anode of the (n/2)th battery cell; and
when n is an odd number, m= (n−1)/2, the first target battery cell is one of a {[(n+1)/2]+1}th battery cell to the nth battery cell, the second target battery cell is one of the 1st battery cell to a {[(n+1)/2]−1}th battery cell, and the second terminal of the inductor is configured to be selectively coupled to an anode or a cathode of a [(n+1)/2]th battery cell.

14. The battery balancing system of claim 13, wherein:
the first target battery cell or the second target battery cell is a battery cell having a highest voltage in the battery pack.

15. The battery balancing system of claim 13, wherein:
the first target battery cell or the second target battery cell is a battery cell having a lowest voltage in the battery pack.

16. The battery balancing system of claim 13, wherein:
a 1st bridge arm of the m bridge arms is configured to be coupled between an anode of the nth battery cell and a cathode of the 1st battery cell;
a 2nd bridge arm of the m bridge arms is configured to be coupled between an anode of a (n−1)th battery cell and a cathode of a 2nd battery cell; and wherein
if n is the even number, a mth bridge arm of the m bridge arms is configured to be coupled between an anode of the [(n/2)+1]th battery cell and a cathode of the (n/2)th battery cell; and
if n is the odd number, the mth bridge arm of the m bridge arms is configured to be coupled between an anode of the {[(n+1)/2]+1}th battery cell and a cathode of the {[(n+1)/2]−1}th battery cell.

17. The battery balancing system of claim 16, further comprising:
m−1 high-side blocking switches, wherein the m−1 high-side blocking switches are coupled in series with a corresponding high-side switch from the 2nd bridge arm to the mth bridge arm, respectively; and
m−1 low-side blocking switches, wherein the m−1 low-side blocking switches are coupled in series with a corresponding low-side switch from the 2nd bridge arm to the mth bridge arm, respectively.

18. A method for balancing a battery pack with n battery cells connected in series, the method comprising:
providing m bridge arms, wherein each of the m bridge arms comprises a high-side switch and a low-side switch coupled in series, and a second terminal of the high-side switch is coupled to a first terminal of the low-side switch to form a middle node, wherein each middle node of the m bridge arms is configured to be coupled to a first terminal of an inductor;
selecting one of the m high-side switches and one of the m low-side switches as a pair of operating switches;
turning on and off the pair of operating switches alternately to couple the first terminal of the inductor to an anode of a first target battery cell or a cathode of a second target battery cell; and wherein
when n is an even number, m=n/2, the first target battery cell is one of a [(n/2)+1]th battery cell to a nth battery cell, the second target battery cell is one of a 1st battery cell to a (n/2)th battery cell, and a second terminal of the inductor is configured to be coupled to an anode of the (n/2)th battery cell; and
when n is an odd number, m= (n−1)/2, the first target battery cell is one of a {[(n+1)/2]+1}th battery cell to the nth battery cell, the second target battery cell is one of the 1st battery cell to a {[(n+1)/2]−1}th battery cell, and the second terminal of the inductor is configured to be selectively coupled to an anode or a cathode of a [(n+1)/2]th battery cell.

19. The method of claim 18, wherein:
a 1st bridge arm of the m bridge arms is configured to be coupled between an anode of the nth battery cell and a cathode of the 1st battery cell;
a 2nd bridge arm of the m bridge arms is configured to be coupled between an anode of a (n−1)th battery cell and a cathode of a 2nd battery cell; and wherein
if n is the even number, a mth bridge arm of the m bridge arms is configured to be coupled between an anode of the [(n/2)+1]th battery cell and a cathode of the (n/2)th battery cell;
if n is the odd number, the mth bridge arm of the m bridge arms is configured to be coupled between an anode of the {[(n+1)/2]+1}th battery cell and a cathode of the {[(n+1)/2]−1}th battery cell.

20. The method of claim 19, further comprising:
coupling m−1 high-side blocking switches series with a corresponding high-side switch from the 2nd bridge arm to the mth bridge arm, respectively; and
coupling m−1 low-side blocking switches in series with a corresponding low-side switch from the 2nd bridge arm to the mth bridge arm, respectively.
